(19) United States
(12) Patent Application Publication
(10) Pub. No.: US 2017/0318361 A1
(43) Pub. Date: Nov. 2, 2017

(54) DEVICES AND METHODS FOR COLLECTING, TRANSMITTING, AND UPDATING DYNAMIC STATUS DATA USING A SHORT RANGE WIRELESS TRANSCEIVER

(71) Applicant: L-3 COMMUNICATIONS CORPORATION, New York, NY (US)

(72) Inventors: Rich COHEN, Alpharetta, GA (US); Jennifer MARTIN, Alpharetta, GA (US)

(73) Assignee: L-3 COMMUNICATIONS CORPORATION, New York, NY (US)

(21) Appl. No.: 15/139,720

(22) Filed: Apr. 27, 2016

(51) Int. Cl. H04Q 9/02

(52) U.S. Cl. CPC H04Q 9/02; H04Q 2209/43

(57) ABSTRACT

The status of a device is continually monitored by a processor or programmable circuitry that has a powered on mode and a powered off mode. The device includes a short range wireless transceiver which allows the status data to be communicated via a wireless connection to an external wireless communication device, whether the processor or programmable circuitry is in the powered on mode or the powered off mode. The wireless communication device, in turn, transmits the status data to a maintenance/repair/monitoring facility via a communication network. This facilitates monitoring of the device in a non-intrusive manner and streamlines maintenance of the device. The wireless communication device also receives information from the external communication device, including information relevant to the operation of the device, and updates the status data based on the received information. This facilitates updates to the device, as needed.

### BACKGROUND

Equipment that is deployed in a field, such as a display on an aircraft, needs to be monitored from time to time to ensure that it is functioning properly and that repairs and/or replacements are provided as needed in an efficient and timely manner.

Currently, monitoring of such equipment is largely a manual task. Problems are not reported until failures occur and are noticed either by an operator of the equipment or maintenance staff testing the equipment. Such problems are then reported to a maintenance facility, and replacement equipment is then sent out.

This manual monitoring takes time and often leads to false pulls of equipment that could otherwise have been easily fixed.

In addition to the manual effort currently required to monitor equipment status, data stored internally in equipment, such as a display, is only currently accessible in a special depot maintenance mode. It sometimes takes weeks to months for a status data to be reported to the maintenance facility and be received in to that facility. The debug process is long and sometimes results in lengthened supply chain cycles due to long lead times of procuring repair parts.

There is therefore a need for a device and method which speeds up the status reporting and maintenance/repair of equipment, such as displays in aircraft.

### SUMMARY OF THE INVENTION

Briefly described, the present invention relates to a short range wireless transceiver that allows data transfer between equipment, such as a display, and an external monitoring system via an external wireless communication device and a communication network, regardless of the power mode (powered-up or powered-down, etc.) of the equipment.

In one preferred form, a device being monitored includes a short range wireless transceiver which allows the device to communicate status data to a remote maintenance/repair/monitoring facility in a non-intrusive manner. The device also includes a processor having a powered on mode and a powered off mode and a memory having instructions that are executable by the processor. The instructions cause the processor to continuously monitor a status of the device and generate dynamic data indicative of the status of the device when the processor is in the powered on mode. The dynamic status data is transmitted via a wireless connection between the wireless transceiver and an external wireless communication device whether the processor is in the powered on mode or the powered off mode. The dynamic data may be transmitted, e.g., responsive to an interrogation from the external wireless communication device. The wireless communication device, in turn, transmits the dynamic status data to a maintenance/repair/monitoring facility via a communication network to facilitate repair and/or replacement of the device as needed. The short range wireless transceiver also allows the device to receive information, including information relevant to the operation of the device, from the external wireless communication device. The information may be used to update the data indicative of the status of the device.

In another preferred form, a device being monitored includes a short range wireless transceiver which allows the device to communicate status data to a remote maintenance/repair/monitoring facility in a non-intrusive manner. The device also includes programmable circuitry having a powered on mode and a powered off mode. The programmable circuitry continuously monitors the status of the device and generates dynamic data indicative of the status of the device when the processor is in the powered on mode. The dynamic status data is transmitted via a wireless connection between the wireless transceiver and an external wireless communication device whether the programmable circuitry is in the powered on mode or the powered off mode. The dynamic data may be transmitted, e.g., responsive to an interrogation from the external wireless communication device. The wireless communication device, in turn, transmits the dynamic status data to a maintenance/repair/monitoring facility via a communication network to facilitate repair and/or replacement of the device as needed. The short range wireless transceiver also allows the device to receive information, including information relevant to the operation of the device, from the external wireless communication device. The information may be used to update the data indicative of the status of the device.

In another preferred form, a method for providing dynamic status data of a device includes continuously monitoring, by a processor, the status of the device when the processor in a powered on mode. Dynamic data indicative of the status of the device is generated when the processor is in the powered on mode. The dynamic data indicative of the status of the device is transmitted from a wireless transceiver included in the device to an external wireless communication device via a wireless connection. whether the processor is in the powered on mode or a powered off mode. The dynamic data may be transmitted, e.g., responsive to an interrogation from the external wireless communication device. The dynamic status data is, in turn, transmitted by the external wireless communication device to a maintenance/repair/monitoring facility via a communication network to facilitate repair and/or replacement of the device as needed. In addition to transmitting information, the wireless transceiver receives information, including information relevant to the operation of the device, from the external wireless communication device. The information may be used to update the data indicative of the status of the device.

### BRIEF DESCRIPTION OF THE DRAWING FIGURES

FIG. 1 illustrates a system in which a monitored device including a short range wireless transceiver may be implemented to collect, transmit, and update dynamic status data according to an illustrative embodiment.

FIG. 2 illustrates a method for collecting, transmitting, and updating dynamic data indicative of a status of a monitored device using a short range wireless transceiver according to an illustrative embodiment.

### DETAILED DESCRIPTION

According to illustrative embodiments, a device is provided with a short range wireless transceiver that facilitates the transmission of data indicative of the status of the device to a remote maintenance/repair/replacement facility. The device is continually monitored by a processor when the processor is in the powered on mode. The processor generates dynamic data indicative of the status of the device, and such data may be transmitted via the wireless transceiver whether the processor is powered on or powered off. In addition, information may be received by the wireless transceiver via an external communication device, and the status data may be update based on the received information.

The devices and methods described herein provide a non-disruptive mechanism for transferring status data between equipment and monitoring facilities, such as between components in vehicles and remote monitoring systems. The short range wireless transceiver, also referred to herein as a wireless interface terminal, is particularly useful, for example, in transferring status data regarding a display component in an airplane to a monitoring system on the ground.

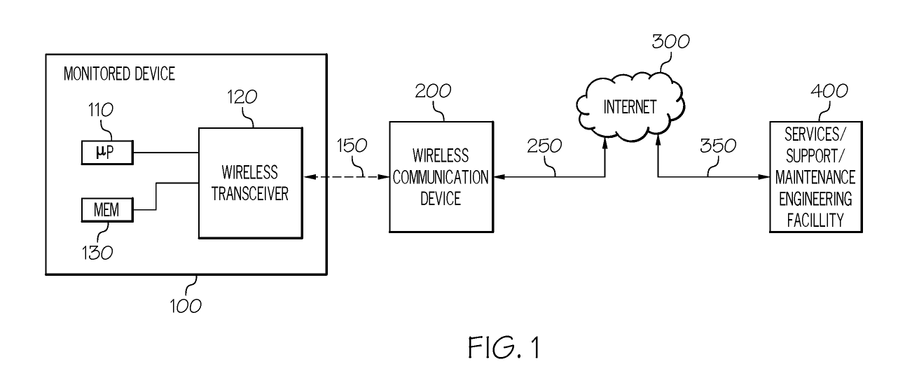

Referring now to the figures, FIG. 1 illustrates a system in which a monitored device including a short range wireless transceiver may be implemented to collect, transmit, and update dynamic status data according to an illustrative embodiment. The monitored device 100 includes a processor 110 for collecting status data on a real time basis and updating the status data as appropriate. In one embodiment, the device 100 also includes a memory 130 storing instructions that are executed by the processor 110 and a database for storing collected status data. The operation of the processor 110 and the memory 130 is described in more detail below.

The device 100 also includes a wireless transceiver or interface terminal 120, preferably a short range wireless interface terminal having wireless communication capabilities for communicating with an external wireless communication device 200 via a bidirectional wireless connection 150. The wireless connection 150 refers to any connection which allows the transfer of data over a distance without a physical connection. This includes, but is not limited to: Near Field Communications, WiFi, Optical (Light) communications, Optical (camera/barcode), Bluetooth, Wireless Personal Area Network (WPAN), etc. The wireless transceiver 120 can be implemented with, e.g., an interface including an antenna or other suitable type of transceiver through which data and signals may be transmitted and received, preferably over a short range wireless connection. The external wireless communication device 200 can be implemented with any suitable device, such as a smartphone, a tablet, etc

The device 100 also includes a power supply (not shown in the interest of simplicity of illustration). The power supply supplies power to the processor 110, the memory 130, and the wireless transceiver 120 when it is switched on. The power may be switched on as desired and/or the processor 110 may be programmed to automatically switch the power on periodically. Power may also be harvested, e.g., from an external power supply and/or the external wireless communication device 200 for use by the device 100. Whether power is supplied by an internal power supply or an external power source, the processor 110 is in the “powered on” mode when power is supplied and is in a “powered off” mode when power is not supplied. Whether the processor 110 is powered on or powered off, data indicative of the status of the device 100 may still be retrieved. If the processor 110 is in the powered on mode, the data retrieved is near real time data. If the processor 110 is in the powered off mode, the data retrieved is the last collected status data.

According to an illustrative embodiment, the wireless transceiver 120 allows a remote service/support/maintenance facility 400 to interrogate the device 100 and retrieve dynamic data indicative of the status of the device 100 without requiring specialized equipment. This is achieved by the facility 400 transmitting requests for status data to the device 100 via a communication network, e.g., the Internet 300 or another suitable communication network. Such requests may be transmitted to the internet over any suitable wired or wireless connection 350. Such requests are, in turn, transmitted from the internet 300 over any suitable connection 250 to the wireless communication device 200 and then transmitted to the wireless transceiver 120 via the wireless connection 150. Responsive to the requests, the processor 110 retrieves the most up to date requested status information (e.g., from a database in the memory 130) and causes this data to be transmitted to the facility 400 via the wireless transceiver 120, the external wireless communication device 200, and the internet 300. Status data may also be retrieved on a periodic basis by the processor 110 and transmitted to the facility 400 without requiring that the facility 400 initiate an interrogation for such data. Data that may be retrieved may include, for example, static data, such as a product number or a serial number, and dynamic data, e.g., a date of a last service, data indicative of an active fault, temperature, a duration the device has been power on, and other data needed for core reporting requirements, such as depot level maintenance data, etc.

In addition to responding to requests for status data, the wireless transceiver 120 serves as a generic interface between devices, such as components in vehicles, and a cloud-based ecosystem of servers or an internet connection. In one aspect, the wireless transceiver may a port allowing connection via a Serial Peripheral Interface or other serial communication link to other components.

The wireless transceiver 120 also enables the device 100 to receive information relevant to the operation of the device 100 from the facility 400 and/or other sources via the communication network 300 and the external wireless communication device 200. For example, the wireless transceiver 120 allows the receipt of data, such as weather maps and radar data that is relevant to the operation of the device 100, such as a display in an airplane, which is not otherwise connected to the Internet. The wireless transceiver 120 also allows a user of the device 100 to receive up-to-date service bulletins, manuals, and other information directly from the device manufacturer and/or the service facility 400. The wireless transceiver 120 also makes it possible to receive instructions via the external communication device 200 for reprogramming the processor and/or programmable circuitry and information for updating the status data as needed. The received information may be loaded into memory by the wireless transceiver 120 in real time, whether or not the device 100 is powered. If the processor 110 is powered, the processor may update the status data with the received data in real time. Otherwise, the status data may be updated with the received data when the processor 110 is powered up. If the external communication device 200 is unpowered, the external communication device 200 may harvest power from the device 100 as needed. The information received via the external communication device 200 and the wireless transceiver 120 may be used to update the status data and/or may be displayed via, e.g., a display in an airplane when the device 100 is powered up.

Referring now to the details of the operation of the processor 110 and the memory 130, it should be understood the description that follows is intended to provide a brief, general description of a suitable environment in which the various aspect of some embodiments of the present disclosure can be implemented. While the description includes a general context of computer-executable instructions, the present disclosure can also be implemented in combination with other program modules and/or as a combination of hardware and software in addition to, or instead of, computer readable instructions.

The term “application”, or variants thereof, is used expansively herein to include routines, program modules, program, components, data structures, algorithms, and the like. Applications can be implemented on various system configurations, including but not limited to single-processor or multiprocessor systems, programmable circuitry, such as Field Programmable Gate Arrays (FPGAs), Complex Programmable Logic Devices (CPLDs) and Application Specific Integrated Circuits, (ASICs), minicomputers, mainframe computers, personal computers, handheld-computing devices, microprocessor-based programmable consumer electronics, combinations thereof, and the like.

The terminology “computer-readable media” and variants thereof, as used in the specification and claims, include non-transitory storage media. Storage media can include volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium, excluding propagating signals, that can be used to store information that can be accessed by, e.g., the processor 110.

Referring again to FIG. 1, the processor 110 included in the device 100 can be any commercially available or custom microprocessor and/or programmable circuitry. The processor 110 shown in FIG. 1 executes instructions stored in a memory 130 to perform operations. It should be appreciated that performance of these operations may include the processor performing the operations directly and/or facilitating, directing, or cooperating with another device or component to perform the operations. It should also be appreciated that the processor 110 may be implemented with programmable circuitry, in which case the memory 130 is not needed to store instructions. Although not shown, it should be further appreciated that the device 100 may include other components, e.g., a temperature sensor, a voltage monitor, etc. Further, it should be appreciated that the memory 130 and/or a database may be integrated into the wireless transceiver 120.

The processor 110 monitors the status of the device 100 and generates data indicative of the status. The data may be stored in a database in the memory 130 and/or in a database in the wireless transceiver 120. The processor 110 receives requests for data, such as, interrogations for status data from the facility 400, via the wireless transceiver 120 and causes the data to be reported to the external communication device 200 via the wireless transceiver 120. Also, the external communication device 200 may simply retrieve information regarding the device 100 via an optical wireless communication, e.g., by scanning a bar code or a QR code on the outside of the device 100. In this instance, the bar code or QR code may be considered the wireless transceiver 120. Further, it should be appreciated that information, such as the QR code may be dynamically updated whether or not the device 100 is in the powered off mode or powered on mode, based on information received via the external communication device 200.

According to an illustrative embodiment, the processor 110 communicates with the memory 130 via, e.g., an address/data bus (not shown). The memory is 130 is representative of the overall hierarchy of memory devices containing the software and data used to implement the functionality of the device 100. The memory 130 can include, but is not limited to the types of memory devices described above. Although not shown for simplicity of illustration, the memory 130 may include several categories of software and data used in the device 100, including applications for monitoring the status of the device 100 and generating status data that may be transmitted, a database for storing collected status data and received status data, etc.

The applications can be stored in the memory 130 and/or firmware (not shown) as executable instructions, and can be executed by the processor 110. The applications include various programs that implement the various features of the device 100. The applications may include an application for performing a built in test (BIT) of the device 100 and applications for collecting the results of the test which are indicative of the status of the device and generating data indicative of the status of the device which may be wirelessly transmitted. The applications may also include an application for updating the status data of the device based on information received from the external communication device 200 and the communication network 300, e.g., data updating a part number or serial number.

While the memory 130 is illustrated as residing proximate the processor 110, it should be understood that at least a portion of the memory 130 can be a remotely accessed storage system. Thus, any of the data, applications, and/or software described above can be stored within the memory 130 and/or accessed via network connections to other data processing systems (not shown).

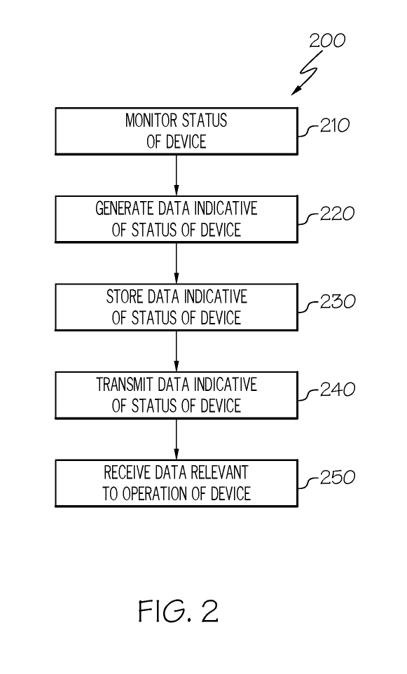

FIG. 2 illustrates a method for collecting, transmitting, and updating dynamic data via a short range wireless interface terminal according to an illustrative embodiment. It should be understood that the steps or other interactions of the illustrated method are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims.

Referring to FIG. 2, the method includes continuously monitoring, by a processor, a status of a device. e.g., a device 100 at step 210. Monitoring includes collecting data indicative of the status of the device 100. Monitoring continues when the processor is in the powered on mode (powered by either an internal power supply or by harvesting power from an external power supply).

At step 220, data indicative of the status of the device that can be wirelessly transmitted is generated by the processor. Such data is generated when the processor is in the powered on mode and may be stored in a database within the memory 130 or may be provided in real time to the wireless transceiver 120.

At step 230, data indicative of the status of the device may be stored, e.g., in the memory 130. The data may be updated with new data, e.g., as the processor 110 collects and generates new data. The data may also be updated with new data received by the wireless transceiver 120 via the external communication device 200 and the communication network 300 (as explained below reference to step 250).

At step 240, data indicative of the status of the device 100 is transmitted from the wireless transceiver 120 via the external wireless communication device 200 and the communication network 300. Such transmission may occur automatically, e.g., at predetermined reporting intervals or may occur responsive to a request received via the external communication device 200. Such transmission may also occur whether the processor 110 is in the powered on mode or a powered off mode. If the processor 110 is in the powered on mode, the data indicative of the status of the device 100 that is transmitted is substantially real-time data. If the processor 110 is in the powered off mode, the data indicative of the status of the device 100 is data that was last collected when the processor was in the powered on mode.

As an optional step, the device 100 receives, via the wireless transceiver 120, information from the external communication device 200 and the communication network 300 that is relevant to operation of the device at step 250. This step may be performed at any time and simultaneously with the other steps shown in FIG. 2. The received information may be used to update the data indicative of the status of the device, as explained above.

The devices and methods implementing the short range wireless transceiver described herein help maintenance issues be identified in a timely manner, which improves overhaul repair turnaround time. Real time data from a monitored device, such as a display unit, can be transmitted on the spot using, for example, a cell phone, a tablet or other communication device, and a user of the monitored device can be provided with information regarding an issue at hand. The original equipment manufacturer (OEM) may be informed of issues before such information is received by an equipment distributor/plant, such that the manufacturer can begin sending a replacement part without waiting on an order from the plant. This streamlines maintenance and repair processes, improves overhaul and repair turn around time, creates a more thorough maintenance data base, and avoids false pulls, i.e., an unneeded replacement of equipment. Use of the wireless transceiver also eliminates the paperwork involved in manually monitoring, reporting, and responding to reports of devices. This results in a reduction of costs.

While the claimed invention has been shown and described in example forms, it will be apparent to those skilled in the art that many modifications, additions, and deletions can be made therein without departing from the spirit and scope of the invention as defined by the following claims.

1. An aircraft display system, comprising:
a display component;
a display component monitoring module comprising a processor, a memory, and wireless transceiver, the processor having a powered on mode and a powered off mode;
the memory having instructions stored thereon which, when executed by the processor, cause the processor to continuously monitor a status of the aircraft display system and generate dynamic data indicative of the status of the aircraft display system when the processor is in the powered on mode;
the wireless transceiver configured to transmit the dynamic data indicative of the status of the aircraft display system via an external wireless communication device and a communication network whether the processor is in the powered on mode or the powered off mode.

2. The aircraft display system of claim 1, further comprising a power supply configured to supply power to the processor, wherein the processor is in the powered on mode when the power supply is supplying power to the processor.

3. The aircraft display system of claim 2, wherein the processor is configured to harvest power from an external source such that the processor is in the powered on mode even when the power supply is not supplying power to the processor.

4. The aircraft display system of claim 3, wherein the processor is configured to harvest power from the external wireless communication device.

5. The aircraft display system of claim 1, wherein if the processor is in the powered on mode, the dynamic data indicative of the status of the aircraft display system is substantially real-time data, and wherein if the processor is in the powered off mode, the dynamic data indicative of the status of the aircraft display system is data that was last generated when the processor was in the powered on mode.

6. The aircraft display system of claim 1, wherein the wireless transceiver transmits the dynamic data indicative of the status of the aircraft display system to a support facility via the external wireless communication device and the communications network.

7. The aircraft display system of claim 1, wherein communication between the wireless transceiver and the external wireless communication device occurs over a wireless connection including at least one of a Bluetooth connection, a Near Field Communications connection, and an optical connection.

8. The aircraft display system of claim 1, wherein the wireless transceiver also transmits static data identifying the aircraft display system.

9. The aircraft display system of claim 1, wherein the wireless transceiver is also configured to receive information from the external wireless communication device including data that is relevant to operation of the aircraft display system to the processor.

10. The aircraft display system of claim 9, wherein the information received from the external wireless communication device is used to update the data indicative of the status of the aircraft display system.

11. A display apparatus, comprising:
a display component;
a display component monitoring module comprising programmable circuitry having a powered on mode and a powered off mode, wherein the programmable circuitry is configured to continuously monitor a status of the display apparatus and generate dynamic data indicative of the status of the display apparatus when the programmable circuitry is in the powered on mode; and
a wireless transceiver configured to transmit the dynamic data indicative of the status of the display apparatus via an external wireless communication device and a communication network, whether the programmable circuitry is in the powered on mode or the powered off mode.

12. The display apparatus of claim 11, wherein the wireless transceiver is further configured to receive information from the external wireless communication device including data that is relevant to the operation of the display apparatus, and wherein the information received from the external communication device is used to update the data indicative of the status of the display apparatus.

13. The display apparatus of claim 12, wherein if the programmable circuitry is in the powered on mode, the information received from the external wireless communication device is used in substantially real-time data to modify the data indicative of the status of the display apparatus.

14. The display apparatus of claim 11, wherein the external wireless communication device has a powered on mode and a powered off mode, and wherein the external communication device is configured to harvest power from the display apparatus when the external wireless communication device is in a powered off mode.

15. A method of operating and monitoring a display device, comprising the steps of:
continuously monitoring, by a processor, a status of a display device when the processor is in a powered on mode;
generating dynamic data indicative of the status of the display device when the processor is in the powered on mode; and
transmitting the dynamic data indicative of the status of the display device via an external wireless communication device and a communication network whether the processor is in the powered on mode or a powered off mode.

16. The method of claim 15, wherein if the processor is in the powered on mode, the dynamic data indicative of the status of the display device that is transmitted is substantially real-time data, and wherein if the processor is in the powered off mode, the dynamic data indicative of the status of the display device is data that was last collected when the processor was in the powered on mode.

17. The method of claim 15, wherein the wireless transceiver transmits the dynamic data indicative of the status of the display device to a support facility via the external wireless communication device and the communications network.

18. The method of claim 15, further comprising transmitting, by the wireless transceiver, static data identifying the display device.

19. The method of claim 15, further comprising receiving, by the wireless transceiver, information from the external wireless communication device and modifying the data indicative of the status of the display device using the received information.

20. The method of claim 12, further comprising receiving power by the processor from an internal power supply or harvesting power by the processor from an external power supply.
